(19) United States
(12) Patent Application Publication
(10) Pub. No.: US 2004/0177067 A1
(43) Pub. Date: Sep. 9, 2004

(54) Directory search method, directory search apparatus, program for implementing and operating the same, and memory medium

(76) Inventor: Mayumi Takeda, Tokyo (JP)

Correspondence Address: CANTOR COLBURN LLP, 55 Griffin Road South, Bloomfield, CT, 06002, US

(21) Appl. No.: 10/788,769

(22) Filed: Feb. 27, 2004

(30) Foreign Application Priority Data
Mar. 6, 2003 (JP) JP2003-059900

(51) Int. Cl. G06F 7/00

(52) U.S. Cl. 707/3

(57) ABSTRACT

There are a step of specifying a directory structure comprising a plurality of hierarchy levels and a step of finding out a specified directory structure from a memory medium loaded with data by a desired directory. This arrangement allows the file storing the image signal to be found out efficiently when an image signal is stored in the file of a directory structure having a predetermined name, even if countless directories have been created in a high-volume memory medium.

### BACKGROUND OF INVENTION

The present invention relates to a directory search method, a directory search apparatus, a program for implementing and operating the same, and a memory medium.

In recent years, instead of the prior art camera based on a silver halide photographic film, a digital camera has come into commercial use, where an optical image from a photographic subject is converted into digital still image signals by an image-capturing device, and is stored into a memory card or the like. Some of the digital still cameras or digital cameras have been developed to a point where sound as well as moving images can be acquired, converted into digital moving image signals and recorded into a memory card or video tape.

Such digital still and moving image signals will be collectively called “image signals” in the following description. Image signals can be stored, for example, into the hard disk of a personal computer. They can be used to reproduce a still image or moving image on the monitor or can be stored into another memory medium.

Let us take an example of the digital still camera. The memory card has a limited capacity. After a predetermined number of shots, there is no remaining shot to be taken or there remains only a little. In order to restart photographing in this case, the image signal in the memory card must be sent to the hard disk of the personal computer or the like. Here the name of the image signal stored in the memory card of the digital still camera is automatically determined by the camera. Such a name includes, for example, “DSC0001.JPG”, “DSC00002.JPG”, DSC00003.JPG” and others. When it is sent to the hard disk of the personal computer, it is preferred that each image signal be stored in the directory of inherent designation as a file, and be sent in this form to the hard disk, to ensure that there will be no confusion with the names of other image signals sent in advance by the same digital still camera.

However, the hard disk of a personal computer contains various kinds of data such as text file and program, in addition to image signals. Thus, mere sending of files to the hard disk is not sufficient. A particular image signal must be found out from several thousand items of image signal, depending on the case. This makes searching efforts difficult.

By contrast, the Patent Document 1 given below discloses the art wherein, for example, when the name of the directory located at the top of the tree structure of a directory created in a hard disk is specified, the tree structure below that directory is analyzed and the detailed information is analyzed and displayed as required.

[Patent Document 1]

Official Gazette of Japanese Patent Tokkaihei 5-012336

According to the prior art disclosed in the Tokkaihei 5-012336, the contents of the directory can be analyzed and displayed. However, there is a problem in that, when many directories and files are present in the directory, much time is required to find out a specified image signal.

### SUMMARY OF THE INVENTION

In view of the prior art described above, it is an object of the present invention to provide a directory search method for more efficient search of a specific directory, directory search apparatus, program and memory medium.

The directory searching method of the first present invention contains a step of specifying a directory structure consisting of a plurality of hierarchy levels, and a step of searching for the aforementioned specified directory structure from the memory medium storing the data through a given directory. Thus, if an image signal is stored in the file contained in the directory structure having a fixed name, for example, the file storing a particular image signal can be found out efficiently, even if countless directories are contained in a high-volume memory medium.

Further, the aforementioned specification is carried out based on the inputted first and second names. The aforementioned searching is effected by extracting a directory structure where a subdirectory including the aforementioned second name is present on the hierarchy level below the directory with the name including the aforementioned first name. Then the directory structure required by the user can be searched.

Also, the aforementioned specification is carried out based on the inputted first and second names. The aforementioned searching is effected by extracting a directory structure where a subdirectory including the aforementioned second name is present on the same hierarchical level as the directory with the name including the aforementioned first name. Then the directory structure desired by the user can be searched.

It is preferred that a further step of displaying at least a part of the searched directory structure be provided. It is also preferred that, when there are a plurality of searched directory structures and one of them is displayed, the display be switched over to the one showing the next directory structure, for example, in response to the user's inputting.

It is also preferred that there be a still further step of selecting part of the directory structure having been found out.

It is also preferred that the aforementioned data contain any one of image data, sound data and sound image data.

The directory search apparatus of the second present invention contains a specifying device for specifying a directory structure consisting of a plurality of hierarchy levels and a search device for searching the aforementioned specified directory structure. Thus, if an image signal, for example, is stored in the file of a directory structure bearing a fixed name, the file storing a particular image signal can be found out efficiently, even if countless directories are formed in a high-volume memory medium.

Further, an input device for inputting the first and second names is provided in order to specify the aforementioned directory structure. The aforementioned search device makes it possible to find out the directory structure desired by the user by extracting a directory structure where a subdirectory including the aforementioned second name is present on the hierarchy level below the directory with the name including the aforementioned first name.

Also, an input device for inputting the first and second names is provided in order to specify the aforementioned directory structure. The aforementioned search device makes it possible to find out the directory structure required by the user by extracting a directory structure where a subdirectory including the aforementioned second name is present on the same hierarchy level as the directory with the name including the aforementioned first name.

Further, it is also preferred to provide a range specification device.

In the foregoing range specification device, the top and bottom levels of the search range in the directory structure are specified, and in the foregoing search device, the directory structure is searched between the specified levels. In this way, the search range can be narrowed to provide a convenient search procedure.

It is also preferred to provide a display device for displaying at least part of the searched directory structure, because of it allows a visual observation of the search result by the user, and is convenient for the subsequent work.

It is also preferred to provide a selection device for selecting at least part of the searched directory structure.

The aforementioned data is preferred to include any one of image data, sound data and sound image data.

It is preferred that the memory medium be loaded with a program that allows the computer to implement the aforementioned directory search method or causes the computer to perform the functions of the aforementioned directory search device.

### BRIEF DESCRIPTION OF THE DRAWINGS

FIG. 1 is a block diagram of a directory search apparatus as an embodiment of the present invention.

FIG. 2 is a drawing representing an example of a directory shown on the display section 5.

FIG. 3 is a drawing representing another example of a directory shown on the display section 5.

FIG. 4 is a drawing representing a further example of a directory shown on the display section 5.

FIG. 5 is a drawing representing a still another example of a directory shown on the display section 5.

FIG. 6 is a drawing representing a still further example of a directory shown on the display section 5.

FIG. 7 is a flowchart of directory search to be conducted using the directory search device shown in FIG. 1.

FIG. 8 is a drawing representing an example of display on the display section 5.

FIG. 9 is a drawing representing another example of display on the display section 5; and

FIG. 10 is another flowchart of directory search to be conducted using the directory search device shown in FIG. 1.

### DETAILED DESCRIPTION OF THE PREFERRED EMBODIMENT

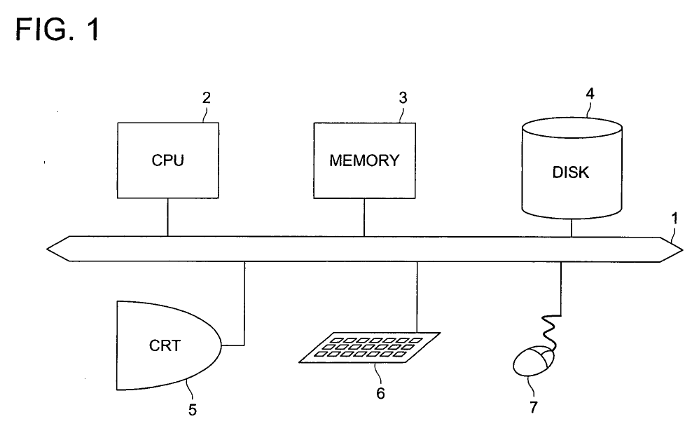

The following describes the preferred embodiments of the present invention with reference to drawings: FIG. 1 is a block diagram of a directory search apparatus as an embodiment of the present invention. A directory search apparatus advantageous to a computer is provided with a bus 1, which is connected with a Central Processing Unit (CPU) 2 for program controlling of the entire apparatus, a memory 3 for temporary storage of the program and working data, and a hard disk 4 for storing the data including various types of files. The bus 1 is also connected with a display section 5, a keyboard 6 for inputting data, and a pointing device 7 including a track ball convenient for coordinate inputting of information, mouse and light pen. The CPU 2 has a predetermined program loaded in the built-in ROM. The directory search, as hereafter described, is carried out based on this program by reading this program out into the memory 3. The keyboard 6 and pointing device (mouse) 7 constitute the input device, specification device, range specification device and selection device, and the CPU 2 constitutes the search device.

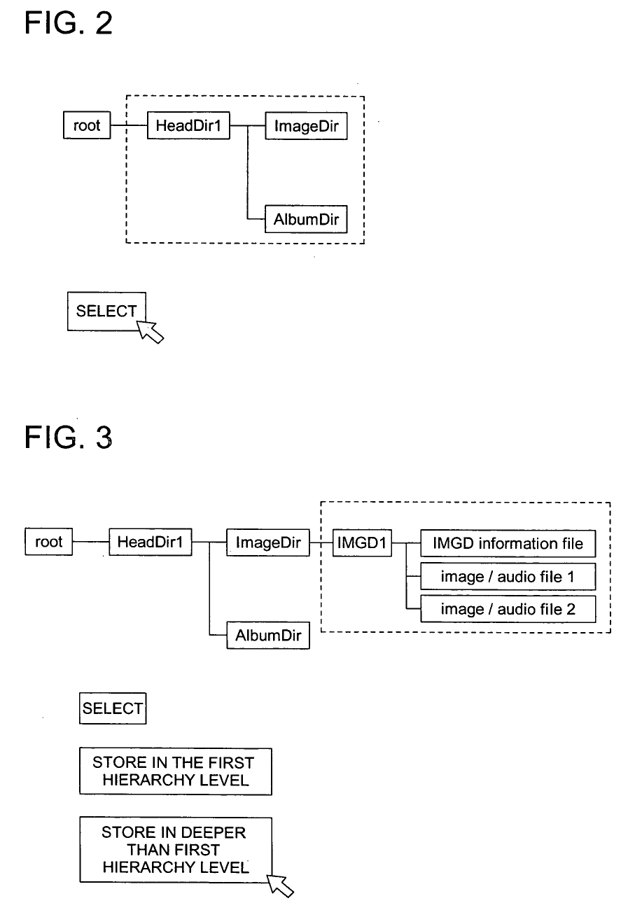

The following describes an embodiment of creating a directory in the hard disk: The specified directory creation tool or the like can be used to create the following directory. FIGS. 2 through 11 illustrate examples of the directories displayed on the display section 5. In FIG. 2, the CPU 2 creates a directory named “HeadDir1” on the hierarchy level below the “root” directory, and a directory named “ImageDir” and a directory name “AlbumDir” on the hierarchy level further below.

Assume that the image signal photographed, for example, by the digital still camera by the user is read from the memory card and is transferred into the hard disk 4. As shown in FIG. 3, in this case, the CPU 2 creates a directory named “IMGD1” (called subdirectory in the following description) below “ImageDir” in the hard disk 4. In this directory, the image signal read from the memory card (not illustrated) is stored in the file format under the names of “image/audiofile1”, “image/audiofile2”, etc. Further, a management file named “IMGDinformationfile” is created on the hierarchy level below the subdirectory named “IMGD1”. This manager file stores the management data associated with the image signal stored in the same subdirectory. The user can stored a required file in the directory named “AlbumDir” whenever required.

Assume that a user is given by his older brother a memory medium such as a CD-R loaded with image signals, and its contents are to be stored in the hard disk 4. Here the user can use by a mouse 7 or the like to select one of the “Store in the first hierarchy level” button and “Store in deeper than second hierarchy level” button displayed on the monitor. If the user clicks on the “Store in the first hierarchy level” button, the CPU 2 creates a new directory named “IMGD2” on the hierarchy level below the “ImageDir” still below the “HeadDir1” (not illustrated), and stores the image signals read out of the CD-R (not illustrated) in the file formats named “image/audiofile1”, “image/audiofile2”, etc. The manager file named “IMGDinformationfile” stores the data similar to the above.

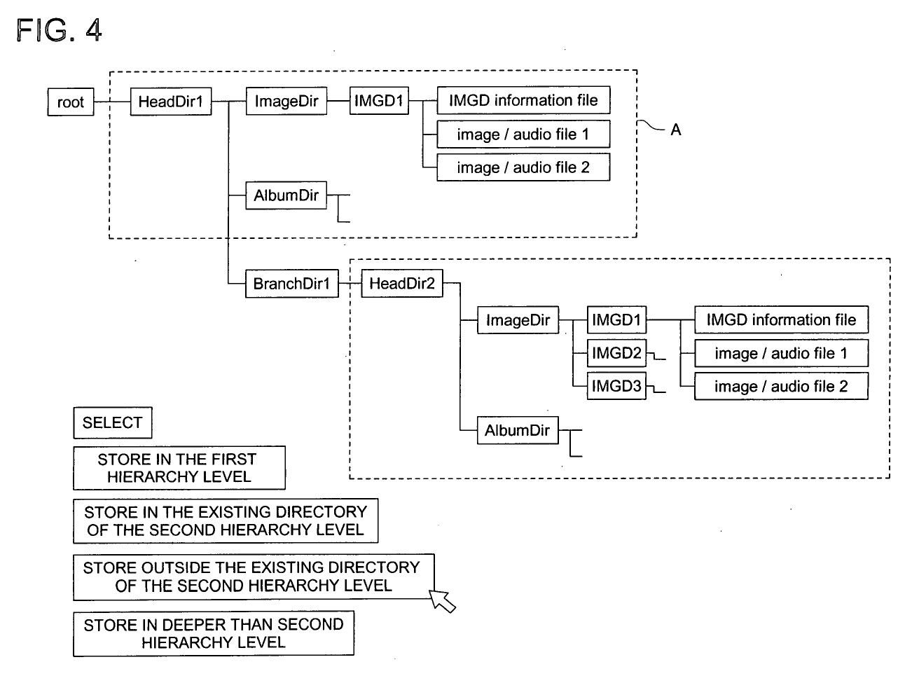

If the user clicks on the “Store in deeper than second hierarchy level” button, the CPU 2 creates a directory named “BranchDir1” in the same hierarchy level as “ImageDir” in the hard disk 4, as shown in FIG. 4. It creates a directory named “HeadDir2” below this level. It further creates a directory named “ImageDir” on the level below that directory and a directory named “AlbumDir” on the same level. Then the CPU 2 creates a subdirectory named “IMGD1” below “ImageDir”. The image signal read out of the CD-R (not illustrated) is stored in this subdirectory in the file formats named “image/audiofile1”, “image/audiofile2”, etc. The manager file named “IMGDinformationfile” stores the data similar to the above.

Assume that a user is given by his younger brother a memory medium such as a CD-R loaded with image signals, and its contents are to be stored in the hard disk 4. Here the user can use by a mouse 7 or the like to select one of the “Store in the first hierarchy level” button, “Store in the existing directory of the second hierarchy level” button, “Store in deeper than second hierarchy level” button and “Store outside the existing directory of the second hierarchy level” button displayed on the monitor.

If the user clicks on the “Store in the first hierarchy level” button, the CPU 2 creates a new directory named, for example, “IMGD2” on the hierarchy level below the “ImageDir” still below the “HeadDir1” (not illustrated), and stores the image signals read out of the CD-R (not illustrated) in the file formats named “image/audiofile1”, “image/audiofile2”, etc. The manager file named “IMGDinformationfile” stores the data similar to the above.

If the user clicks on the “Store in the existing directory of the second hierarchy level” button, the CPU 2 creates a new directory named, for example, “IMGD4” on the hierarchy level below the “ImageDir” still below the “HeadDir2” (not illustrated), and stores the image signals read out of the CD-R (not illustrated) in the file formats named “image/audiofile1”, “image/audiofile2”, etc. The manager file named “IMGDinformationfile” stores the data similar to the above.

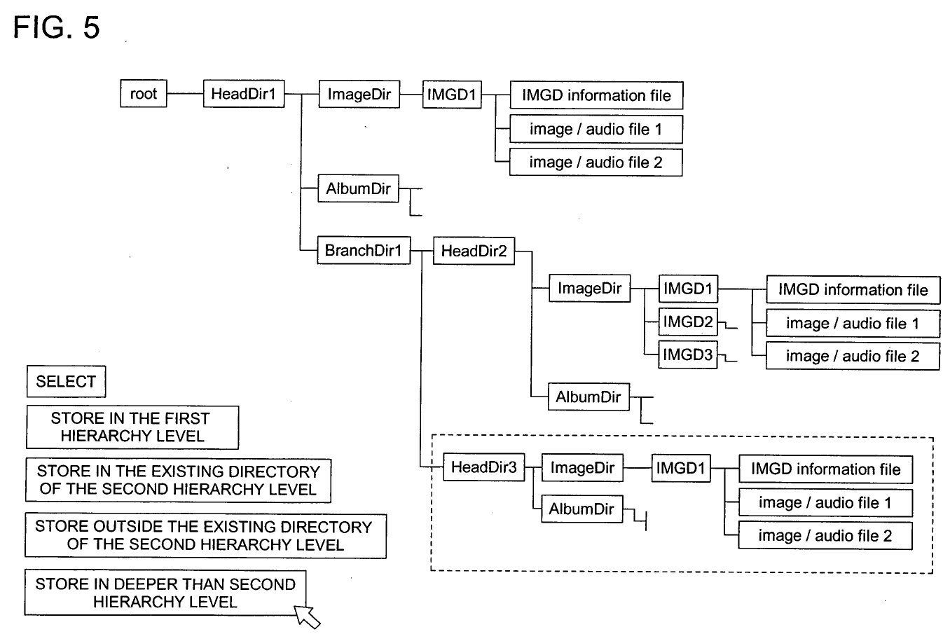

If the user clicks on the “Store outside the existing directory of the second hierarchy level” button, the CPU 2 creates a new directory named “HeadDir3” on the hierarchy level below the directory named “BranchDir1” (namely on the same level as the directory “HeadDir2) as shown in FIG. 5. It further creates a directory named “ImageDir” below this directory and a directory named “AlbumDir” in the same hierarchy level. Then the CPU 2 creates a subdirectory named “IMGD1” below “ImageDir”. The image signal read out of the CD-R (not illustrated) is stored in this subdirectory in the file formats named “image/audiofile1”, “image/audiofile2”, etc. The manager file named “IMGDinformationfile” stores the data similar to the above.

If the user clicks on the “Store in deeper than second hierarchy level” button, the CPU 2 creates a new directory named “BranchDir2” on same hierarchy level as the HeadDir2” (not illustrated), and a directory named “HeadDir3” below this directory. Then the CPU 2 creates a directory named “ImageDir” below this directory and a directory named “AlbumDir” on the same level. Further, the CPU 2 creates a subdirectory named “IMGD1” in the hierarchy level below the “ImageDir”. The image signal read out of the CD-R (not illustrated) is stored in this subdirectory in the file formats named “image/audiofile1”, “image/audiofile2”, etc. The manager file named “IMGDinformationfile” stores the data similar to the above.

Assume further that a user is given by his same younger brother at a different time a memory medium such as a CD-R loaded with image signals, and its contents are to be stored in the hard disk 4. Here the user can use by a mouse 7 or the like to select one of the “Store in the first hierarchy level” button, “Store in the existing directory of the second hierarchy level” button, “Store outside the existing directory of the second hierarchy level” button and “Store in deeper than second hierarchy level” button displayed on the monitor.

To avoid reduplication, the description will be omitted regarding the cases where the user clicks on the “Store in the first hierarchy level” button, “Store in the existing directory of the second hierarchy level” button and “Store outside the existing directory of the second hierarchy level” button.

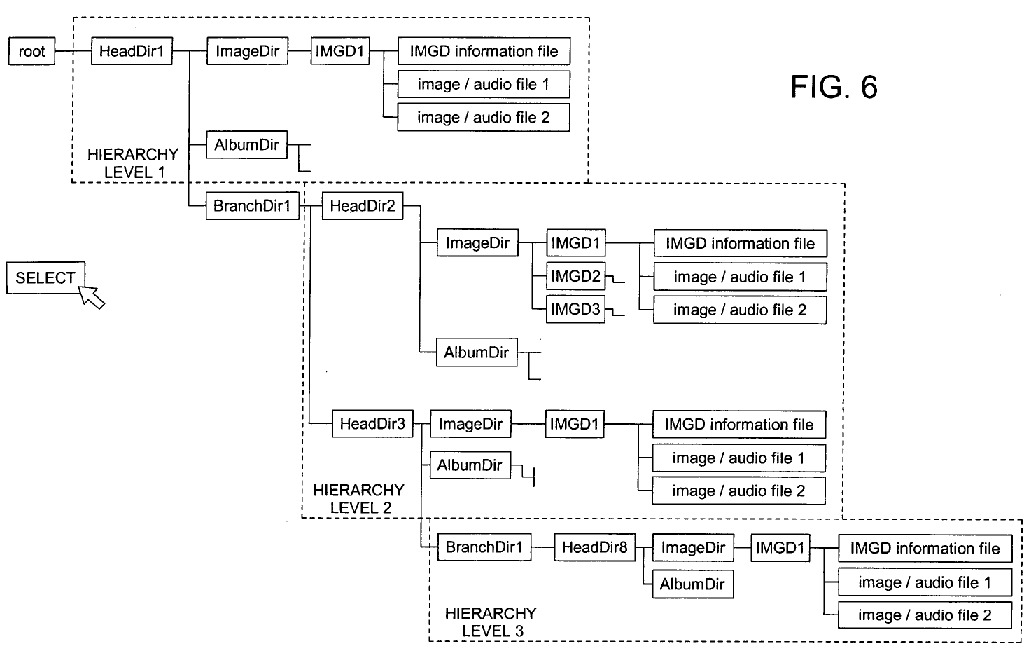

By contrast, when the user clicks on the “Store in deeper than second hierarchy level” button, the CPU 2 creates a directory named “BranchDir2” below “HeadDir3 (or 2)” in the hard disk 4, as shown in FIG. 6. It creates a directory named “HeadDir8” below that level, a directory named ImageDir” further below that level, and a directory named “AlbumDir” on the same level. Further, the CPU 2 creates a subdirectory named “IMGD1” in the hierarchy level below the “ImageDir”. The image signal read out of the CD-R (not illustrated) is stored in this subdirectory in the file formats named “image/audiofile1”, “image/audiofile2”, etc. The manager file named “IMGDinformationfile” stores the data similar to the above. These steps are repeated to create directories.

As shown in FIG. 6, the directories described above are formed in a plurality of hierarchy levels; namely, the first hierarchy level below the “HeadDir1”, the second hierarchy level below the “BranchDir1”, the third hierarchy level below the “BranchDir2” and so forth. This directory structure permits efficient saving of image signal files while organizing them in order. In this case, it can be seen that, for example, the image signal file given by the younger brother of the user is located somewhere below “HeadDir3”. This arrangement ensures easy search operations.

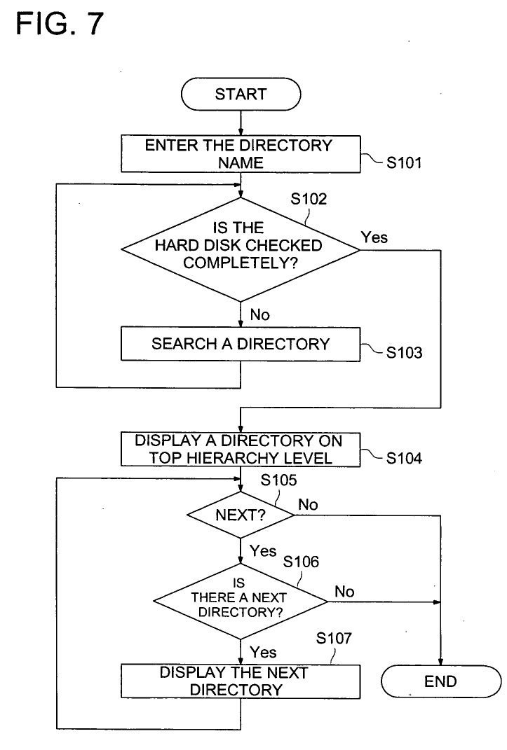

FIG. 7 is a flowchart of directory search to be conducted using the directory search device shown in FIG. 1. In the Step S101 of FIG. 7, let us assume that a plurality of directory names are entered by a user. For example, the user enters the directory names “ImageDir” as the first name and “IMGD1” as the second name, in the example given in FIG. 2. They can be entered by the user using the keyboard 6, clicking of the mouse or the like or selecting from a plurality of names determined by default in advance. In response to the entered names, the CPU 2 specifies the directory structure.

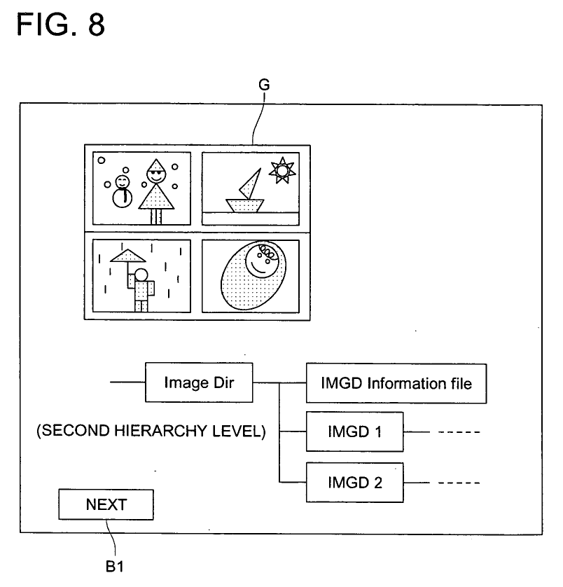

In the Step S102, the CPU 2 accesses the hard disk 4 to search all items to see whether or not there is a directory named “IMGD1” in the hierarchy level below the directory with the name “ImageDir” (Step S103). Here the CPU 2 allows the top level directory to be displayed on the display section 5 as the result of search operation (Step S104). According to the preferred mode of display, at least “ImageDir” directory and “IMGD1” directory should be displayed on the screen of the display section 5. In the example shown in FIG. 8, all the subdirectories in the hierarchy level below the directory with the name “ImageDir” are displayed. In this case, the representative image G of the IMGD1” directory should be displayed together. It should be noted, in this case, that the hierarchy level of the directory currently being display on the display screen (second layer in FIG. 8) is displayed, and the next directory structure is displayed when the user has clicked on the Next button B1.

If the directory on display is the one desired by the user, searching operation will be terminated by selecting such a directory by the mouse or the like. A required processing is applied the directory searched by the user when a desired application is started subsequently. However, if the display directory is not the one required by the user, the CPU 2 displays the next directory (Step S107), if any (Step S106), in response to the next instruction inputted by the user (Step S105). If there is no next directory, processing terminates. This embodiment allows a particular directory structure (there is a directory named “IMGD1” in the hierarchy level below the directory with the name “ImageDir””) to be displayed in conformity to the user's requirements. Thus, when one wishes to start a particular application such as image processing software, for example, the structure of the particular directory including the image file is kept always on display, whereby the directory or file contained therein is displayed by clicking on this directory. This arrangement ensures easy subsequent processing.

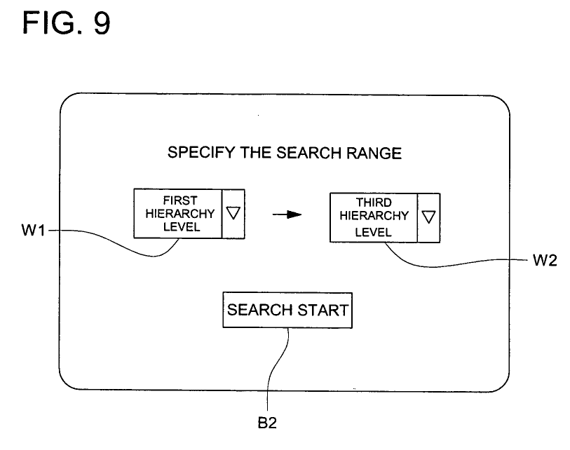

According to the aforementioned embodiment, the entire directory range, for example, is specified by default for the items to be searched. In one variation of the present embodiment, the range of searching the directory structure can be narrowed and specified. To specify the aforementioned range, as shown in FIG. 9, it is possible to make such arrangements that the user can use a keyboard 6 or mouse 7 to input a desired hierarchy level into the first input section W1 and the second input section W2 shown on the screen of the display section 5. By clicking on the Search Start button B2 by the mouse 7 or the like, searching operation can be performed, in the range from the hierarchy level entered from the first input section W1 (top level of search range, the first hierarchy level here), to the hierarchy level entered form the second input section W2 (the bottom level of search range, the third hierarchy level here). For searching, only the hierarchy levels for starting and terminating the search operation can be specified.

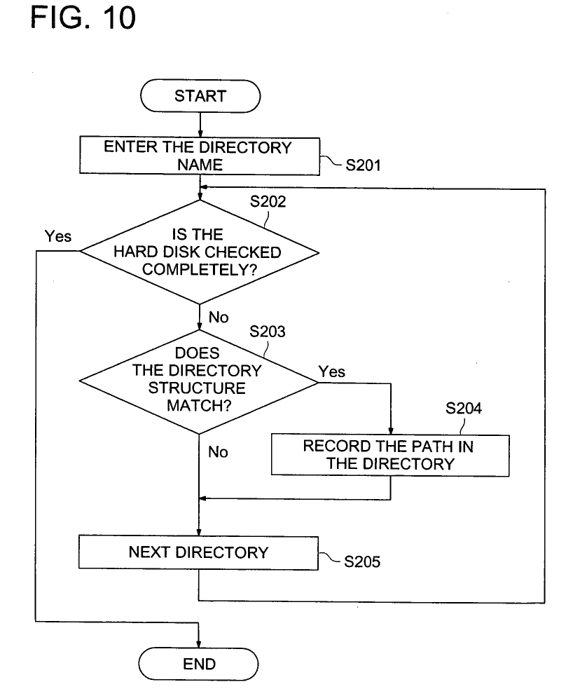

FIG. 10 is a flowchart for searching of another directory using the directory search device shown in FIG. 1. This search operation is intended only to store the path name of a specific directory structure; it is not displayed. In Step S201 shown in FIG. 10, a plurality of directory names are entered.

In Step S202, the CPU 2 accesses the hard disk 4, and performs search operation in Step S203 to see whether or not the directory on the top level is structured in such a way that the directory named “IMGD1” is present in the hierarchy level below the directory with the name “ImageDir”. If matching of the directory structure is found, the depth of the path (the level counted from the top level directory) is memorized (Step S204). If matching of the directory structure is not found, comparison is made with the next directory (on the same or lower level) (Step S205), without the path being memorized. In this way, search operation is carried out for all directories, until the search operation terminates (Step S202). According to this embodiment, the path and depth of the matching directory structure are memorized, thereby ensuring easier access by the user.

When a specific directory structure is to be searched in a variation of the aforementioned embodiment, it is possible to search a directory structure where a directory named “AlbumDir” is present in the same hierarchy level as the directory with the name “ImageDir”. Alternatively, it is also possible to perform a search operation to see whether or not there is a file named “IMGDinformationfile” in the directories named “IMGD1” in the hierarchy level below the directory with the name “ImageDir”, and whether or not there is a specific type of file such as an image file.

In the aforementioned embodiment, arrangement is made in such a way as to search a directory structure where a directory with the name matching the entered second name is present in the hierarchy level below the directory with the name matching the entered first name. However, the present invention is not restricted thereto. For example, when determining the directory name, it is possible to consider that the “IMGD” is fixed, and the user adds a string of desired alphanumeric codes to it, whereby the file created in the Christian Era year of 2002 is assigned with “IMGD02ab”, and that created in the Christian Era year of 2003 is assigned with “IMGD03ab”. In such a case, when search is made using “IMGD0” as the second name, “IMGD02ab” and “IMGD03ab” contain “IMGD0”. This arrangement allows the directories with both names to be searched. When search is made using “IMGD03” as the second name, only the directory with name “IMGD03ab” including “IMGD03” is searched. Thus, this method improves search efficiency. The same applies to the case with the first name.

The above description has been made with reference to the embodiment of the present invention. It should not be understood, however, that the present invention is limited only to the above description. The present invention can be embodied in a great number of variations with appropriate modification and improvement. For example, it is possible to make such arrangements that the first and second names having been entered are stored in a hard disk and can be used as default names in and after the next operation.

The present invention provides a directory search method, a directory search apparatus, a program and a memory medium that ensure more efficient searching of a specified directory.

What is claimed is:

1. A directory searching method of searching a prescribed directory contained in a directory structure which is stored in a hierarchical structure including plural directory structures in a storage medium and includes at least two directories of a directory having a first name and a directory having a second name; comprising steps of;
inputting the first name and the second name with a inputting device,
searching the plural directory structures based on the first name so as to extract a directory structure having the first name,
searching the extracted directory structure based on the second name so as to extract a directory having the second name, and
obtaining the prescribed directory contained in the extracted directory.

2. The directory searching method of claim 1, wherein the second name of directory is present on below the first name of directory.

3. The directory searching method of claim 1, wherein the second name of directory is present on the same hierarchy level as the first name of directory.

4. The directory searching method of claim 1, further comprising step of:
displaying at least a part of the extracted directory structure.

5. The directory searching method of claim 1, further comprising step of:
selecting a prescribe directory contained in part of the extracted directory structure.

6. The directory searching method of claim 1, wherein a directory having a set data contains at least one of image data, sound data and sound image data.

7. A directory searching apparatus of searching a prescribed directory contained in a directory structure which is stored in a hierarchical structure including plural directory structures in a storage medium and includes at least two directories of a directory having a first name and a directory having a second name; comprising of;
an inputting device to input the first name and the second name with a inputting device,
a searching device of searching the plural directory structures based on the first name so as to extract a directory structure having the first name,
a searching device of searching the extracted directory structure based on the second name so as to extract a directory having the second name, and
a obtaining device to obtain the prescribed directory contained in the extracted directory.

8. The directory searching apparatus of claim 7, wherein the second name of directory is present on below the first name of directory.

9. The directory searching apparatus of claim 7, wherein the second name of directory is present on the same hierarchy level as the first name of directory.

10. The directory searching apparatus of claim 7, further comprising of;
a range specification device to specify a search range.

11. The directory searching device apparatus of claim 10, wherein the search range is the top and bottom level in the directory structure.

12. The directory searching apparatus of claim 7, further comprising of:
a displaying device display at least a part of the extracted directory structure.

13. The directory searching apparatus of claim 7, further comprising of:
a selecting device select a prescribe directory contained in part of the extracted directory structure.

14. The directory searching apparatus of claim 7, wherein the directory having a set data contain at least one of image data, sound data and sound image data.

15. A directory searching program comprising step of controlling a computer to function as a directory searching method of claim 1.

16. A directory searching program comprising a controlling section to control a computer to function as a directory searching apparatus of claim 7.

17. A storage medium comprising data corresponding to the directory searching program of claim 15.

18. A storage medium comprising data corresponding to the directory searching program of claim 16.
